(19) United States
(12) Patent Application Publication
(10) Pub. No.: US 2020/0061399 A1
(43) Pub. Date: Feb. 27, 2020

(54) Venus Flu Trap

(71) Applicant: Martin T. Wade, Nevada, TX (US)

(72) Inventor: Martin T. Wade, Nevada, TX (US)

(21) Appl. No.: 16/547,861

(22) Filed: Aug. 22, 2019

Related U.S. Application Data
(60) Provisional application No. 62/721,385, filed on Aug. 22, 2018.

(51) Int. Cl. A62B 18/10; A62B 23/02

(52) U.S. Cl. CPC A62B 18/10; A41D 13/1138; A62B 23/02

(57) ABSTRACT

The present invention discloses an anti-flu mask or a respirator to filter air and prevent spreading of virus or pathogens through airborne. The anti-flu mask comprises a filter, a check valve, and a dial or a selector. The filter is configured to filter the airflow and capture up to 99.7% of all particulates or infectious materials. The check valve or one-way valve is configured to control the airflow and allows the air in one direction. The selector is configured to slide smoothly over the check valve and to make the airflow path selection by a user.

### BACKGROUND OF THE INVENTION

### A. Technical Field

The present invention generally relates to an anti-flu mask. More specifically, the present invention relates to an anti-flu mask or a respirator to filter air and prevent spreading of virus or pathogens through airborne by wearing the anti-flu mask on a user's face.

### B. Description of Related Art

Influenza, commonly known as “the flu”. It is an infectious disease caused by an influenza virus, that is spread from person to person by airborne means. The breathing of the infected person commonly transmits the invasion of the human by a virus or bacteria or pathogens. This process is called a transmissible disease or a communicable disease and it is an illness resulting in infection. A non-infected person may acquire the disease by breathing in the organisms that are present in the air from the infected persons breathing, coughing, or any other methods of expelling air from the sick person's lungs. Bodily fluids discharged from the lungs or throat of the infected individual containing the virus or pathogens become airborne, a hazard for anyone in the vicinity that might inhale the contaminated air. The virus or pathogens may be spread through any activities such as raising of dust particles, spraying liquids, flushing toilets, any event that generates aerosol particles becomes a potential source of infection.

If a person goes into a room occupied by a flu infected person, they could easily acquire the infection as the sick person breathes, coughs, or sneezes, casting droplets of water laden with influenza viruses into the air. If any of these very small (5 micron or slightly larger) water droplets happen to be inhaled or captured on the hands and wiped onto the lips or nostrils, the person is easily infected. The flu causes life threatening infections to children or elderly people.

The treatment for patients carrying an airborne illness creates infection hazards for professional health care personnel, family and any other care workers that could be exposed. Separation of infected individuals helps limit the spread of the virus or pathogens, but health care workers, family, or other healthy individuals become exposed to the disease by treating or visiting the affected persons. Generally, face masks are used to avoid exposure from the virus or pathogens in the surrounding air.

Currently, the face masks are limited to cover the mouth and nose of a user. Loose fitting of the face mask allows air to pass between the user face and edge of the mask. The face masks are not able to filter the leaking air around the edges. The simple face mask has only a limited amount of filtering ability. These face masks are filtered the air partially in such situations.

Therefore, there is a need to provide an anti-flu mask for preventing and controlling the infectious diseases by airborne means. There is a need to provide an anti-flu mask to avoid leakages of the air around the edges of the anti-flu mask. There is also a need to provide an anti-flu mask to conform to almost any aged people or user's face.

### SUMMARY OF THE INVENTION

The present invention generally discloses an anti-flu mask. Further, the present invention discloses an anti-flu mask or a respirator to filter air and prevent spreading of virus or pathogens through airborne by wearing the anti-flu mask on a user's face.

According to the present invention, the anti-flu mask comprises a filter, a check valve, and a dial or a selector. In one embodiment, the filter is an injection molded part having a threaded assembly. In one embodiment, the filter of the anti-flu mask is configured to detachably attached to an upper portion of the anti-flu mask. In one embodiment, the filter is configured to filter the airflow. In one embodiment, the filter will be treated with a silver ion nano-particle fluid. In one embodiment, the filter could be a screw-on filter.

In one embodiment, the check valve or one-way valve is disposed on the lower portion of the anti-flu mask. In one embodiment, the check valve or one-way valve is configured to control the airflow and allows the air in one direction. In one embodiment, the check valve is configured to shut off airflow completely. In one embodiment, the check valve is made of, but not limited to, a silicone rubber. In one embodiment, the check valve having multiple set of channels or leaves. The one set of channels is positioned to open upon breathing in or inhaling and closes upon exhalation. The other set of channels is positioned to open upon exhalation and closes upon inhaling.

In one embodiment, the dial or selector could be an injection molded part. In one embodiment, the selector is made of, but not limited to, a polypropylene plastic. In one embodiment, the selector is mating with medical grade silicone rubber components. In one embodiment, the selector is configured to slide smoothly over the check valve and to make the airflow path selection by the user.

In one embodiment, the anti-flu mask further includes, multiple hubs. In one embodiment, the filter is disposed on one hub mounted in front of the anti-flu mask. In another embodiment, the filter is detachably attached to the hub via a fastener, but not limited to a rivet.

In one embodiment, the anti-flu mask further comprises a position indicator. In one embodiment, the position indicator is disposed below the check valve. The position indicator has multiple texts or marks such as “sick”, “not sick” and “full filter”. The marks or texts are imprinted on the surface of the position indicator. In one embodiment, the position indicator is configured to represent breathing modes to the user.

In one embodiment, the anti-flu mask further comprises multiple strap loops and elastic straps. In one embodiment, the strap loops are made of a material, but not limited to, a rubber, a stainless steel, an iron and a steel. In one embodiment, the strap loops are molded to the anti-flu mask. In one embodiment, the elastic straps are removably attached to the strap loops. In one embodiment, the elastic straps are threaded though the strap loops and secured to hold them. In one embodiment, the elastic straps are configured to adjust and allows the user to tighten the anti-flu mask to seal along the facial surface.

In one embodiment, the anti-flu mask further comprises a face seal. In one embodiment, the face seal is disposed or attached to the edges of the anti-flu mask. In one embodiment, the face seal is made of a material, but not limited to, a rubber material. In one embodiment, the face seal is configured to prevent air from leaking inside to out or vice versa. In one embodiment, the face seal is attached to the edge of the anti-flu mask via an adhesive or a fastening means.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 shows a perspective view of an anti-flu mask worn by a user in an embodiment of the present invention.

FIG. 2A shows a front view of an anti-flu mask in an embodiment of the present invention.

FIG. 2B shows a side view of an anti-flu mask in an embodiment of the present invention.

FIG. 2C shows a rear view of an anti-flu mask in an embodiment of the present invention.

FIG. 2D shows a front view of a check valve of the anti-flu mask in an embodiment of the present invention.

FIG. 3 shows an exploded view of the anti-flu mask in an embodiment of the present invention.

FIG. 4A shows a front view of the check valve of the anti-flu mask at first position in an embodiment of the present invention.

FIG. 4B shows a front view of the check valve of the anti-flu mask at second position in an embodiment of the present invention.

FIG. 4C shows a front view of the check valve of the anti-flu mask at third position in an embodiment of the present invention.

FIG. 5 shows a perspective view of the anti-flu mask with a face seal in an embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

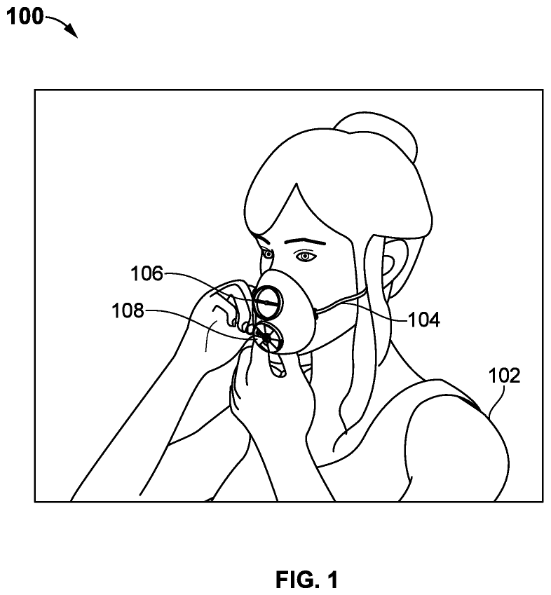

Referring to FIG. 1, the perspective view of an anti-flu mask 100 worn by a user 102 is illustrated. In one embodiment, the anti-flu mask 100 is configured to filter the air and prevents spreading of infectious diseases. In one embodiment, the user 102 could wear on the face by using elastic straps 104 provided to the anti-flu mask 100. In one embodiment, the anti-flu mask 100 is configured to prevent spreading of virus or pathogens through airborne. In one embodiment, the anti-flu mask 100 is providing security to health care professionals, family members, and any one visiting or tending to a person suffering from infectious diseases. In one embodiment, the anti-flu mask 100 is an injection molded part. In one embodiment, the anti-flu mask 100 is made of, but not limited to, a rubber material. The molded anti-flu mask 100 fits snugly over the nose, across the cheeks, and under the chin to create the optimum seal while maintaining the comfort required for long wearing periods.

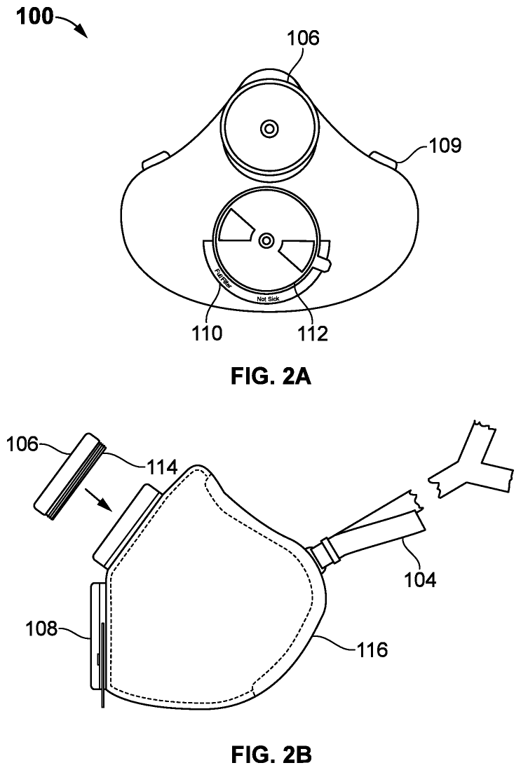

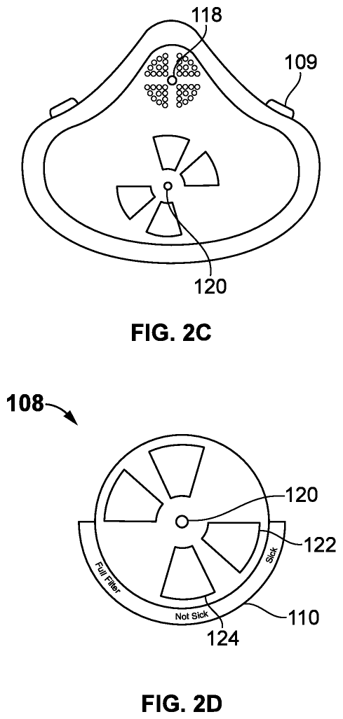

In one embodiment, the anti-flu mask 100 comprises a filter 106, a check valve 108, and a dial or a selector 112 and elastic straps 104. In one embodiment, the filter 106 is disposed on an upper portion of the anti-flu mask 100. In one embodiment, the check valve or one-way valve 108 is disposed on the lower portion of the anti-flu mask 100 as depicted in FIG. 1. In one embodiment, the elastic straps 104 is attached to strap loops 109 of the anti-flu mask (shown in FIG. 2A).

Referring to FIG. 2A, the front view of an anti-flu mask 100 is illustrated. In one embodiment, the filter 106 of the anti-flu mask 100 is configured to detachably attached to an upper portion of the anti-flu mask 100. In one embodiment, the filter 106 is configured to filter the air flow. In one embodiment, the dial or selector 112 could be an injection molded part. In one embodiment, the selector 112 is made of, but not limited to, polypropylene plastic. In one embodiment, the selector 112 is mating with medical grade silicone rubber components. In one embodiment, the selector 112 is configured to slide smoothly over the check valve 108 (shown in FIG. 2D) and to make the airflow path selection by the user 102 (shown in FIG. 1).

In one embodiment, the anti-flu mask 100 further comprises a position indicator 110. In one embodiment, the position indicator 110 is disposed below the check valve 108 as depicted in FIG. 2A. The position indicator 110 has multiple texts such as “sick”, “not sick” and “full filter” are imprinted on the surface. In one embodiment, the position indicator 110 is configured to represent breathing modes to the user 102 (shown in FIG. 1). The user 102 (shown in FIG. 1) could easily select the any one of the desired breathing mode such as “sick”, “not sick” and “full filter” by rotating the selector 112 to cover texts on the position indicator 110. The settings of “sick” and “not sick” allow unfiltered airflow, in or out, which increases the comfort level for the wearer by restricting the continuous filter operation.

Referring to FIG. 2B, the side view of an anti-flu mask 100 is illustrated. In one embodiment, the filter 106 is an injection molded part having a threaded assembly 114. The injection molded threaded assembly will retain the appropriate filter 106 from the anti-flu mask 100. The filter 106 will capture up to 99.7% of all particulates or infectious materials, 3.0 microns in diameter, including most airborne viruses, which are typically transported in the 5 micron or larger droplets of excretions. When the filter 106 is become laden with particulate or viral contaminants, the user 102 (shown in FIG. 1) could replace with another filter. In one embodiment, the filter 106 could be treated with a silver ion nano-particle fluid to retain the sterility and freshness of the disinfectant. The used filter 106 should be placed in a zip-lock bag, then sealed, and discarded in the trash. In one embodiment, the filter 106 could be a screw on filter.

In one embodiment, the elastic straps 104 are removably attached to the strap loops 109. The elastic straps 104 are threaded though the strap loops 109 and secured to hold them. In one embodiment, the strap loops 109 are made of, but not limited to a rubber or a metal includes stainless steel, iron and steel. In one embodiment, the strap loops 109 are molded into the rubber and become a permanent part of the anti-flu mask 100. The elastic straps 104 are configured to adjust and allows the user 102 (shown in FIG. 1) to tighten the anti-flu mask 100 to seal along all facial surfaces yet provides the optimum in comfortable wear.

Referring to FIG. 2C, the rear view of an anti-flu mask 100 is illustrated. In one embodiment, the anti-flu mask 100 further includes, multiple hubs 118 and 120. In one embodiment, the filter 106 is disposed on one hub 118 mounted in front of the anti-flu mask 100. The filter 106 is pressed on the hub 118, so that it is tightly attached to the hub 118 in front side of the anti-flu mask 100. In another embodiment, the filter 106 is detachably attached to the hub 118 via a fastener, but not limited to a rivet. In one embodiment, the selector 112 is disposed on other hub 120 mounted in front of the anti-flu mask 100. The selector 112 is pressed against the hub 120, so that it is sealed the gap between the ambient air and check valve 108 (shown in FIG. 2C). In one embodiment, the selector 112 is configured to slide smoothly over the check valve 108 (shown in FIG. 2C) and to make the airflow path selection.

Referring to FIG. 2D, the front view of a check valve 108 of the anti-flu mask 100 is illustrated. In one embodiment, the check valve or one-way valve 108 is configured to control the airflow and allows the air in one direction. In one embodiment, the check valve 108 is made of, but not limited to a silicone rubber, so that the entire anti-flu mask 100 could be immersed for cleaning after the filter 106 is removed. In one embodiment, the check valve 108 having multiple set of channels or leaves (122 and 124). The one set of channels 122 is positioned to open upon breathing in or inhaling and closes upon exhalation. The other set of channels 124 is positioned to open upon exhalation and closes upon inhaling.

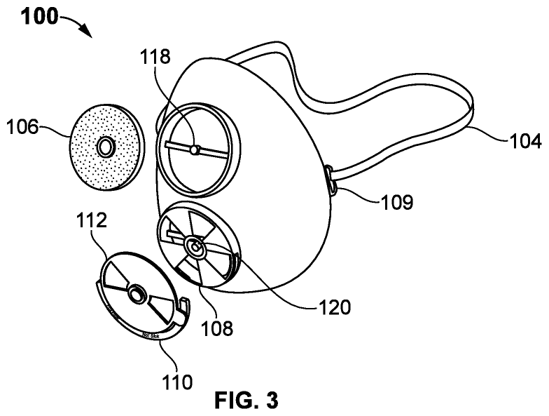

Referring to FIG. 3, the exploded view of the anti-flu mask 100 is illustrated. In one embodiment, the anti-flu mask 100 has multiple breathing channel settings, that can protect individuals from infecting each other. In one embodiment, the filter 106 is a N99 filter, that filters up to 99% of the particulate matter of the organic vapors and has been treated with silver nanoparticles to kill any microbials that come into contact with the treated media. In one embodiment, the filter 106 is treated with free silver ion disinfectant. The filter 106 could be easy to replace with other, when it is become laden with particulate or viral contaminants.

In one embodiment, the silver ion disinfectant is used by allying the fluid to the filter 106, so that nano-particle free silver ions (Ag+) coat the strands of the filter 106. The nano-particle free silver ions (Ag+) are filtered out the microbials and come into contact with the disinfectant. These free silver ions (Ag+) are harmless to the user 102 (shown in FIG. 1) by wearing the anti-flu mask 100 but are deadly to encountered the microbials by inactivating the protein in the cell and then engaging in DNA deactivation of the virus or or pathogens. The disinfectant is simple to synthesize and has a long operating life. The filter 106 could be assembled and made available in a configuration that is made to N95 filter standards, which will strain out up to 95% of particulates 3.0 microns and larger.

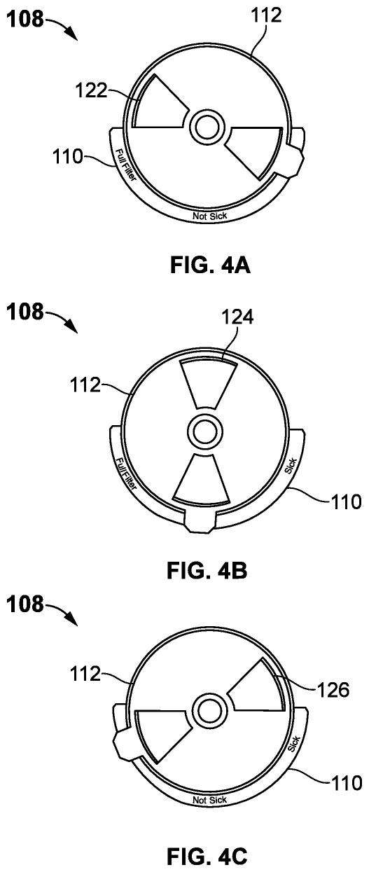

Referring to FIG. 4A, the front view of the check valve 108 of the anti-flu mask 100 at first position is illustrated. In one embodiment, the user 102 (shown in FIG. 1) could set the anti-flu mask 100 in three positions or settings via the selector 112. In one embodiment, the first setting is for sick patients. In an exemplary embodiment, if the user 102 (shown in FIG. 1) is suffering from the influenza diseases or flu, then the user 102 (shown in FIG. 1) could select the “sick” breathing mode by rotating or sliding the selector 112 at first position to cover the “sick” text on the position indicator 110. In one embodiment, the one set of channels or leaves 122 of the check valve 108 is positioned to open in sick breathing mode and allowing fresh unfiltered air for inhaling or breathing in and closed upon exhalation and forcing the air through the filter 106 for filtering the air. In this “sick” breathing mode, the anti-flu mask 100 provide protection for everyone or non-users around the user or patient affected by the infectious diseases.

Referring to FIG. 4B, the front view of the check valve 108 of the anti-flu mask 100 at second position is illustrated. In one embodiment, the second position or setting is for a healthy user. In an exemplary embodiment, if the user 102 (shown in FIG. 1) is a healthy person, then the user 102 (shown in FIG. 1) could select the “not sick” breathing mode by rotating or sliding the selector 112 at second position to cover the “not sick” text on the position indicator 110. In this “not sick” breathing mode, the outside air is filtered by the filter 106 for inhaling or breathing in. The user 102 (shown in FIG. 1) could breathe the purified air through the filter 106 of the anti-flu mask 100. In one embodiment, the another set of channels or leaves 124 of the check valve 108 is positioned to open for allowing the outward forcing air upon exhalation. In this “not sick” breathing mode, the anti-flu mask 100 provide purified air to the user 102 (shown in FIG. 1) for inhaling.

Referring to FIG. 4C, the front view of the check valve 108 of the anti-flu mask 100 at third position is illustrated. In one embodiment, the third position or setting is for any users. In one embodiment, the user 102 (shown in FIG. 1) could select the “full filter” breathing mode by rotating or sliding the selector 112 at third position to cover the “full filter” text on the position indicator 110. In this “full filter” breathing mode, the outside air is filtered by the filter 106 for inhaling or breathing in. The user 102 (shown in FIG. 1) could breathe the purified air through the filter 106 of the anti-flu mask 100 upon inhaling. The filter 106 also allows the outward forcing air upon exhalation. In one embodiment, the block portion 126 could block the outward forcing air and direct the outward forcing air towards the filter 106. In this “full filter” breathing mode, the anti-flu mask 100, provide purified air to the user 102 (shown in FIG. 1) for inhaling and prevents the spreading of the virus or pathogens through airborne upon exhalation. The anti-flu mask 100 protects the user 102 (shown in FIG. 1) from the infectious diseases or the flu by wearing on the face of the user 102 (shown in FIG. 1).

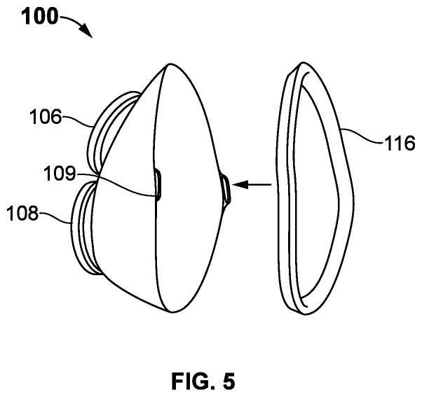

Referring to FIG. 5, the perspective view of the anti-flu mask 100 with a face seal 116 is illustrated. In one embodiment, the face seal 116 is disposed or attached to the edges of the anti-flu mask 100. In one embodiment, the face seal 116 is made of a material, but not limited to, a rubber material. The face seal 116 has soft edges, which is enough to conform to almost any adult or teen's face. In one embodiment, the face seal 116 is configured to prevent air from leaking inside to out or vice versa. The face seal 116 surface on the face is molded to prevent air leaks, directing the airflow through the selected channels or filter in the anti-flu mask 100. In one embodiment, the face seal 116 is attached to the edge of the anti-flu mask 100 via an adhesive or a fastening means.

An additional positive factor in wearing the anti-flu mask 100 is that it also prevents the user 102 (shown in FIG. 1) from rubbing or touching their face or nose, virtually eliminating a very high contamination risk. The anti-flu mask 100 is made of a durable rubber. The anti-flu mask 100 is highly resistant to household and hospital chemicals and is typically used in this type of application. The anti-flu mask 100 is supplied in almost any vibrant color, so a distinctive color may be chosen to enhance the product recognition factor, which can dramatically improve the market adoption of the product.

The anti-flu mask 100 is designed to be aesthetic and effective in the application. The relative ease of manufacture and the moderately inexpensive components provide good marketability for the manufacturer. The user 102 benefits from comfortable wear and the interception of most airborne infectious diseases, which should provide considerable market interest for this mask product.

Preferred embodiments of this invention are described herein, including the best mode known to the inventors for carrying out the invention. It should be understood that the illustrated embodiments are exemplary only and should not be taken as limiting the scope of the invention.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings in the foregoing descriptions. Although specific terms may be employed herein, they are used only in generic and descriptive sense and not for purposes of limitation. Accordingly, the present invention is not limited to the specific embodiments illustrated herein.

1) An anti-flu mask to filter air and prevent the spreading of virus or pathogens through airborne transmission, comprising:
a filter being configured to detachably attach to an upper portion of the anti-flu mask to filter airflow
a check valve to control airflow, and
a selector to select the airflow by a user.

2) An anti-flu mask to filter air and prevent the spreading of virus or pathogens through airborne transmission as in claim 1, wherein the anti-flu mask includes a respirator.

3) An anti-flu mask to filter air and prevent the spreading of virus or pathogens through airborne transmission as in claim 1, wherein the filter includes a silver ion nano-particle fluid.

4) An anti-flu mask to filter air and prevent the spreading of virus or pathogens through airborne transmission as in claim 1, wherein the filter is threadably attached to the anti-flu mask

5) An anti-flu mask to filter air and prevent the spreading of virus or pathogens through airborne transmission as in claim 1, wherein the check valve is s disposed on the lower portion of the anti-flu mask.

6) An anti-flu mask to filter air and prevent the spreading of virus or pathogens through airborne transmission as in claim 5, wherein the check valve controls airflow to allow airflow in one direction only and to shut off the airflow completely.

7) An anti-flu mask to filter air and prevent the spreading of virus or pathogens through airborne transmission as in claim 1, wherein the check valve includes a plurality of channels.

8) An anti-flu mask to filter air and prevent the spreading of virus or pathogens through airborne transmission as in claim 7, wherein the first channel is configured to open upon breathing in or inhaling and closes upon exhalation.

9) An anti-flu mask to filter air and prevent the spreading of virus or pathogens through airborne transmission as in claim 8, wherein the second channel is configured to open upon exhalation and closes upon inhaling.

10) An anti-flu mask to filter air and prevent the spreading of virus or pathogens through airborne transmission as in claim 1, wherein the selector is configured to slide smoothly over the check valve and to make and airflow path selection by the user.

11) An anti-flu mask to filter air and prevent the spreading of virus or pathogens through airborne transmission as in claim 1, wherein the anti-flu mask further includes a plurality of hubs.

12) An anti-flu mask to filter air and prevent the spreading of virus or pathogens through airborne transmission as in claim 11, wherein the filter is disposed on a first hub mounted on the anti-flu mask.

13) An anti-flu mask to filter air and prevent the spreading of virus or pathogens through airborne transmission as in claim 12 wherein the anti-flu mask includes a fastener to fasten and is detachably attached to the hub.

14) An anti-flu mask to filter air and prevent the spreading of virus or pathogens through airborne transmission as in claim 1, wherein the anti-flu mask further includes a position indicator to correspond to breathing modes of the user.

15) An anti-flu mask to filter air and prevent the spreading of virus or pathogens through airborne transmission as in claim 14, wherein the position indicator is disposed below the check valve.
